(19) United States
(12) Patent Application Publication
(10) Pub. No.: US 2026/0081381 A1
(43) Pub. Date: Mar. 19, 2026

(54) STACKED CONNECTOR

(71) Applicant: SUMITOMO WIRING SYSTEMS, LTD., Mie (JP)

(72) Inventor: Atsuya IKEDA, Mie (JP)

(21) Appl. No.: 19/321,640

(22) Filed: Sep. 8, 2025

(30) Foreign Application Priority Data
Sep. 13, 2024 (JP) 2024-159067

(51) Int. Cl. H01R 13/514

(52) U.S. Cl. CPC H01R 13/514

(57) ABSTRACT

A stacked connector includes: a first housing and a second housing stacked on each other; a first terminal fitting and a second terminal fitting; and a retainer configured to be shared between both the first housing and the second housing. The retainer includes: a first locking portion disposed so as to be engageable with the first terminal fitting accommodated in a first cavity of the first housing, in a detachment direction from the first cavity; a second locking portion disposed so as to be engageable with the second terminal fitting accommodated in a second cavity of the second housing, in a detachment direction from the second cavity; and an elastic locking portion configured to lock the first housing in a state in which the first locking portion is disposed so as to be engageable with the first terminal fitting.

### CROSS-REFERENCE TO RELATED APPLICATIONS

This application is based on and claims priority from Japanese Patent Application No. 2024-159067, filed on Sep. 13, 2024, with the Japan Patent Office, the disclosure of which is incorporated herein in its entirety by reference.

### TECHNICAL FIELD

The present disclosure relates to a stacked connector.

### BACKGROUND

A connector described in JP 2017-004736 A includes a first housing, a second housing stacked on the first housing, a plurality of first terminal fittings accommodated in the first housing, and a plurality of second terminal fittings accommodated in the second housing. The first housing includes a first lance that is flexible and locks the first terminal fittings, a first retaining portion that prevents the second terminal fittings from becoming detached, and a locking portion. The second housing includes a second lance that is flexible and locks the second terminal fittings, a second retaining portion that prevents the first terminal fittings from becoming detached, and a lock receiving portion that is elastically engaged with the locking portion.

When assembling the connector, first, the first terminal fittings are inserted into the first housing, and the second terminal fittings are inserted into the second housing. Next, the second housing is attached to the first housing from above. When the first terminal fittings are inserted into the first housing at their proper positions and the second terminal fittings are inserted into the second housing at their proper positions, the first retaining portion faces the second terminal fittings in the detachment direction, and the second retaining portion faces the first terminal fittings in the detachment direction. As a result, the locking portion reaches a position where it can be engaged with the lock receiving portion, and the first housing and the second housing are held in a stacked state.

If at least one of the plurality of first terminal fittings is not inserted into the first housing at its proper position (hereinafter referred to as “half-inserted state”), the second retaining portion interferes from above with the half-inserted first terminal fitting, causing the second housing to lift from the upper surface of the first housing. As a result, the locking portion cannot engage with the lock receiving portion, and assembly of the first and second housings is prevented. Similarly, if at least one of the plurality of second terminal fittings is in a half-inserted state in the second housing, the locking portion likewise cannot engage with the lock receiving portion, and assembly of the first and second housings is prevented. Therefore, it can be determined that one of the first or second terminal fittings is in a half-inserted state based on the fact that assembly of the first housing and the second housing is prevented.

The technique disclosed in JP 2017-004736 A is for detecting a half-inserted state of either the first or second terminal fitting based on whether or not the locking portion of the first housing can engage with the lock receiving portion of the second housing. In contrast, there is also a known technique for detecting a half-inserted state of a terminal fitting using a retainer attached to the housing, unlike the technique disclosed in JP 2017-004736 A (see, for example, JP 2023-129827 A). The retainer functions to secondarily prevent the terminal fitting from becoming detached and is usually provided separately from the housing.

### SUMMARY

For example, in a case where the half-inserted state of a terminal fitting is to be detected for the stacked connector disclosed in JP 2017-004736 A, it is conceivable to use a retainer having a half-insertion detection function, as disclosed in JP 2023-129827 A, by employing a different approach from that of JP 2017-004736 A. However, if retainers are provided separately for the first housing and the second housing, the number of parts increases, which is undesirable.

Therefore, the present disclosure aims to provide a stacked connector capable of preventing an increase in the number of parts when performing half-insertion detection of terminal fittings using a retainer.

A stacked connector according to the present disclosure includes: a first housing having a first cavity; a first terminal fitting configured to be accommodated in the first cavity; a second housing having a second cavity; a second terminal fitting configured to be accommodated in the second cavity; and a retainer configured to be shared between both the first housing and the second housing, wherein the first housing and the second housing are stacked on each other, and a first locking portion disposed so as to be engageable with the first terminal fitting accommodated in the first cavity, in a detachment direction from the first cavity; a second locking portion disposed so as to be engageable with the second terminal fitting accommodated in the second cavity, in a detachment direction from the second cavity; and an elastic locking portion configured to lock the first housing in a state in which the first locking portion is disposed so as to be engageable with the first terminal fitting.

According to the present disclosure, it is possible to provide a stacked connector capable of detecting a half-inserted state of a terminal fitting by means of a retainer, while preventing an increase in the number of parts.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a stacked connector according to a first embodiment.

FIG. 2 is a side sectional view showing the stacked connector according to the first embodiment accommodated in an outer housing.

FIG. 3 is a bottom view of a first housing in the stacked connector according to the first embodiment.

FIG. 4 is a front view of the first housing in the stacked connector according to the first embodiment.

FIG. 5 is a plan view of a retainer in the stacked connector according to the first embodiment.

FIG. 6 is a front view of the retainer in the stacked connector according to the first embodiment.

FIG. 7 is an enlarged side view showing a state in which a first elastic locking portion and a second elastic locking portion of the retainer in the stacked connector according to the first embodiment are locked to main locking protrusions of the first housing and a second housing, respectively.

FIG. 8 is an enlarged front view showing that the retainer has reached a temporary locking position with respect to the first housing in the stacked connector according to the first embodiment.

FIG. 9 is an enlarged front view showing that the retainer has reached a main locking position with respect to the first housing in the stacked connector according to the first embodiment.

FIG. 10 is an enlarged front view showing that the retainer has reached a temporary locking position with respect to the second housing in the stacked connector according to the first embodiment.

FIG. 11 is an enlarged front view showing that the retainer has reached a main locking position with respect to the second housing in the stacked connector according to the first embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.
(1) A stacked connector according to the present disclosure includes: a first housing having a first cavity; a first terminal fitting configured to be accommodated in the first cavity; a second housing having a second cavity; a second terminal fitting configured to be accommodated in the second cavity; and a retainer configured to be shared between both the first housing and the second housing, wherein the first housing and the second housing are stacked on each other, and the retainer includes: a first locking portion disposed so as to be engageable with the first terminal fitting accommodated in the first cavity, in a detachment direction from the first cavity; a second locking portion disposed so as to be engageable with the second terminal fitting accommodated in the second cavity, in a detachment direction from the second cavity; and an elastic locking portion configured to lock the first housing in a state in which the first locking portion is disposed so as to be engageable with the first terminal fitting.

When the first terminal fitting is accommodated in the first cavity at its proper position, the first locking portion of the retainer faces the first terminal fitting in the detachment direction, and the elastic locking portion of the retainer can lock the first housing. On the other hand, if the first terminal fitting is in a half-inserted state not accommodated in the first cavity at its proper position, the first locking portion abuts against the first terminal fitting from a direction intersecting the detachment direction, for example, and the elastic locking portion cannot lock the first housing at its main locking position or the like. Accordingly, the retainer is prevented from being attached to the first housing at its proper position such as the main locking position. Therefore, it can be determined that the first terminal fitting is in a half-inserted state in the first cavity based on the fact that the retainer is prevented from being attached at the proper position.

When the first terminal fitting is accommodated in the first cavity at the proper position and the retainer is locked to the first housing, the task of stacking the second housing onto the first housing is carried out. If the second terminal fitting is accommodated in the second cavity at its proper position, the second locking portion of the retainer faces the second terminal fitting in the detachment direction, and the first housing and the second housing can reach a proper stacked state (for example, a state in which the mutually opposing surfaces of the first housing and the second housing are in face-to-face contact). On the other hand, if the second terminal fitting is in a half-inserted state with respect to the second cavity, the second locking portion abuts against the second terminal fitting from a direction intersecting the detachment direction, for example, and the first housing and the second housing cannot reach the proper stacked state. Therefore, it can be determined that the second terminal fitting is in a half-inserted state in the second cavity based on the fact that the first housing and the second housing do not reach the proper stacked state. According to the present disclosure, the retainer is sequentially engaged with the first housing and the second housing, and the half-inserted state of the first terminal fitting with respect to the first cavity and the half-inserted state of the second terminal fitting with respect to the second cavity can be confirmed sequentially. In particular, since the retainer is shared between both the first housing and the second housing, the number of parts can be reduced compared to a case in which retainers are provided separately for the first housing and the second housing.
(2) In the stacked connector described in (1) above, it is preferable that the elastic locking portion includes a first elastic locking portion configured to lock the first housing, and a second elastic locking portion configured to lock the second housing in a state in which the second locking portion faces the second terminal fitting, and the first housing and the second housing are held in a stacked state by the retainer.

If the second terminal fitting is in a half-inserted state with respect to the second cavity, the second locking portion abuts against the second terminal fitting from a direction intersecting the detachment direction, for example, and the second elastic locking portion cannot lock the second housing at its main locking position or the like. Accordingly, the retainer is prevented from being attached to the second housing at its proper position such as the main locking position. Therefore, it can be determined that the second terminal fitting is in a half-inserted state in the second cavity based on the fact that the retainer is prevented from being attached at the proper position. In particular, according to (2) above, the locking between the housings for maintaining the stacked state of the first housing and the second housing can be omitted from each of the first housing and the second housing, and therefore the structures of the first housing and the second housing can be simplified.
(3) In the stacked connector described in (2) above, it is preferable that, when a direction in which the first housing and the second housing are stacked is defined as a height direction and a direction intersecting the height direction is defined as a width direction, the retainer includes a retainer body portion having the first locking portion and the second locking portion protruding respectively from two sides in the height direction, and a connecting portion protruding in the width direction from an intermediate portion in the height direction of the retainer body portion, the first elastic locking portion protrudes from a leading end portion of the connecting portion in a protruding direction toward one side in the height direction, and the second elastic locking portion protrudes from the leading end portion of the connecting portion in the protruding direction toward the other side in the height direction.

According to (3) above, by adjusting the ranges in which the first elastic locking portion and the second elastic locking portion are connected to the connecting portions and the the amount by which they protrude from the connecting portions, it is possible to adjust the elastic reaction forces of the first elastic locking portion and the second elastic locking portion to appropriate values.
(4) In the stacked connector described in (3) above, it is preferable that the retainer has a symmetric shape with respect to a symmetry line passing through the center of the retainer in the height direction and extending in the width direction.

According to (4) above, when attaching the retainer to each of the first housing and the second housing, the orientation of the retainer in the height direction need not be distinguished, thereby improving workability during attachment of the retainer.
(5) In the stacked connector according to any one of (1) to (4) above, it is preferable that the first housing and the second housing have the same shape.

According to (5) above, the first housing and the second housing can be assembled in a stacked state without distinguishing them from each other, thereby improving workability during assembly. In addition, the number of types of parts used to form the stacked connector can be reduced.

### Details of Embodiments of the Present Disclosure

Specific examples of the embodiments of the present disclosure will be described below with reference to the drawings. It should be noted that the present invention is not limited to the illustrated examples but is defined by the scope of the claims, and it is intended to include all modifications within the meaning and scope of equivalents to the claims.

### First Embodiment

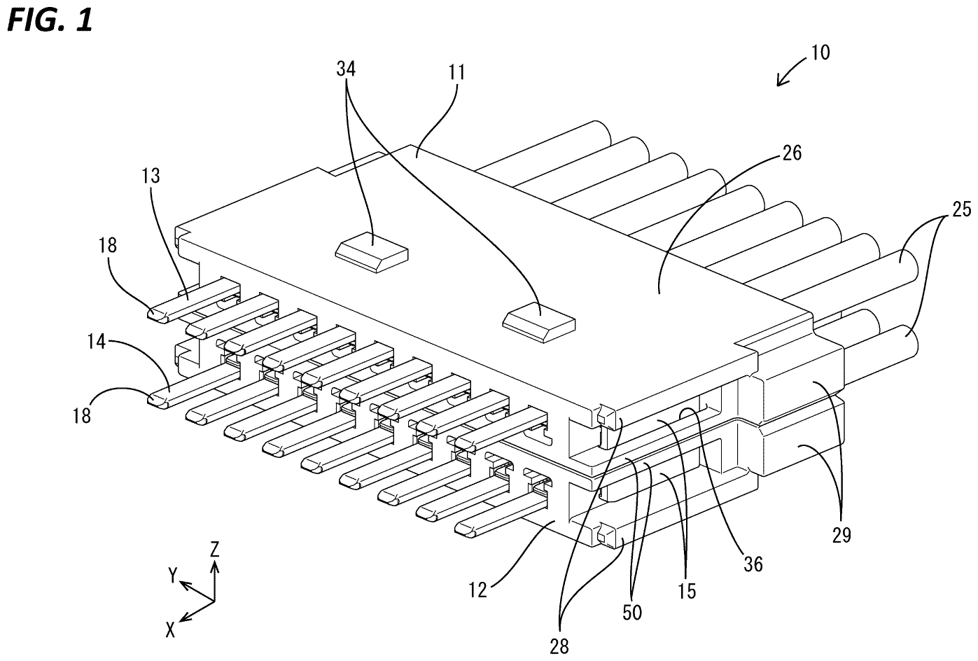

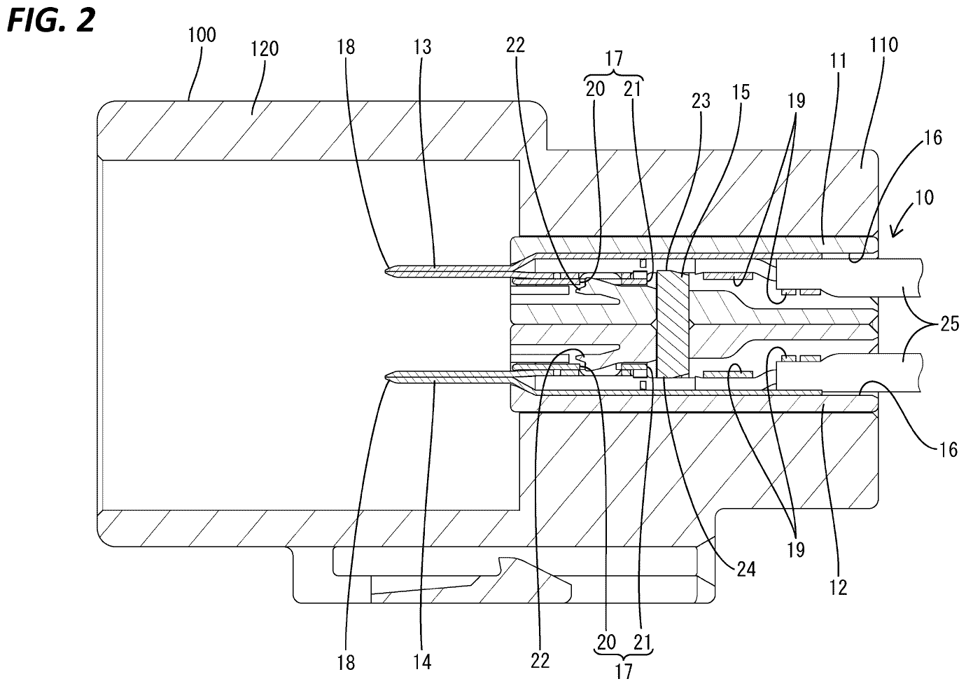

A specific example according to a first embodiment of the present disclosure will be described with reference to FIGS. 1 to 11. As shown in FIGS. 1 and 2, a stacked connector 10 according to the first embodiment includes a first housing 11 and a second housing 12 that are stacked on each other, first terminal fittings 13 and second terminal fittings 14 that are accommodated in the first housing 11 and the second housing 12, respectively, and a single retainer 15 attached to the first housing 11 and the second housing 12. The stacked connector 10 is accommodated in an outer housing 100 shown in FIG. 2. The outer housing 100 is fitted to a mating connector (not shown). It should be noted that, in the following description, the top-bottom direction corresponds to the stacking direction in which the first housing 11 and the second housing 12 are stacked. Regarding the front-rear direction, the direction in which the outer housing 100 is fitted to the mating connector is referred to as a forward direction. The left-right direction is the direction intersecting both the front-rear direction and the top-bottom direction. The top-bottom direction is synonymous with the height direction, and the left-right direction is synonymous with the width direction. In FIG. 1, the X direction, the Y direction, and the Z direction represent the forward direction, the leftward direction, and the upward direction, respectively. These reference directions do not necessarily coincide with the reference directions in a state where the stacked connector 10 is mounted on a vehicle or the like (not shown).

### Outer Housing 100

The outer housing 100 is made of synthetic resin and, as shown in FIG. 2, includes a connector housing portion 110 that accommodates the first housing 11 and the second housing 12 in a stacked state, and a rectangular tubular hood portion 120 that protrudes forward from the connector housing portion 110. The mating connector is fitted into the hood portion 120 of the outer housing 100.

### First Terminal Fittings 13, Second Terminal Fittings 14

In the first embodiment, the first terminal fittings 13 and the second terminal fittings 14 have the same shape. Therefore, the configuration of the first terminal fittings 13 will be described below, and the configuration of the second terminal fittings 14 will be described as necessary. In the respective configurations of the first terminal fittings 13 and the second terminal fittings 14, identical reference signs are given to identical portions, and unless otherwise specified, the same names will be used in the description.

As shown in FIG. 2, each first terminal fitting 13 is formed into an elongated shape in the front-rear direction, for example, by bending a conductive metal plate. Each first terminal fitting 13 includes a terminal body portion 17, a tab 18 extending forward from the terminal body portion 17, and a barrel portion 19. The terminal body portion 17 has a rectangular tube shape elongated in the front-rear direction. The terminal body portion 17 includes a lance receiving portion 20 and a lock engagement portion 21. In the first embodiment, the lance receiving portion 20 is configured as a lance hole formed in one wall of the terminal body portion 17. The lance receiving portion 20 is locked to a lance 22, which will be described later, of the first housing 11. The lock engagement portion 21 is disposed rearward of the lance receiving portion 20. The lock engagement portion 21 is formed as the rear end edge of the terminal body portion 17. The lock engagement portion 21 of each first terminal fitting 13 faces a first locking portion 23, which will be described later, of the retainer 15. The respective lock engagement portions 21 of the second terminal fittings 14 face second locking portions 24, which will be described later, of the retainer 15. The tab 18 is disposed so as to protrude into the hood portion 120 when the stacked connector 10 is accommodated in the connector housing portion 110 of the outer housing 100. The barrel portion 19 is continuous with the rear of the terminal body portion 17. A wire 25 is crimped by the barrel portion 19 and mechanically connected.

### First Housing 11, Second Housing 12

In the first embodiment, the first housing 11 and the second housing 12 have the same shape, just as the first terminal fitting 13 and the second terminal fitting 14 do. Therefore, the configuration of the first housing 11 will be described below, and the configuration of the second housing 12 will be described as necessary. In the respective configurations of the first housing 11 and the second housing 12, identical reference signs are given to identical portions, and unless otherwise specified, the same names will be used in the description. Note that the first housing 11 and the second housing 12 are assembled in opposite orientations in the top-bottom direction. Therefore, the orientation of the first housing 11 in the top-bottom direction described below is opposite to the orientation of the second housing 12 in the top-bottom direction. In the first embodiment, for convenience, the first housing 11 is assumed to be assembled in a stacked manner above the second housing 12.

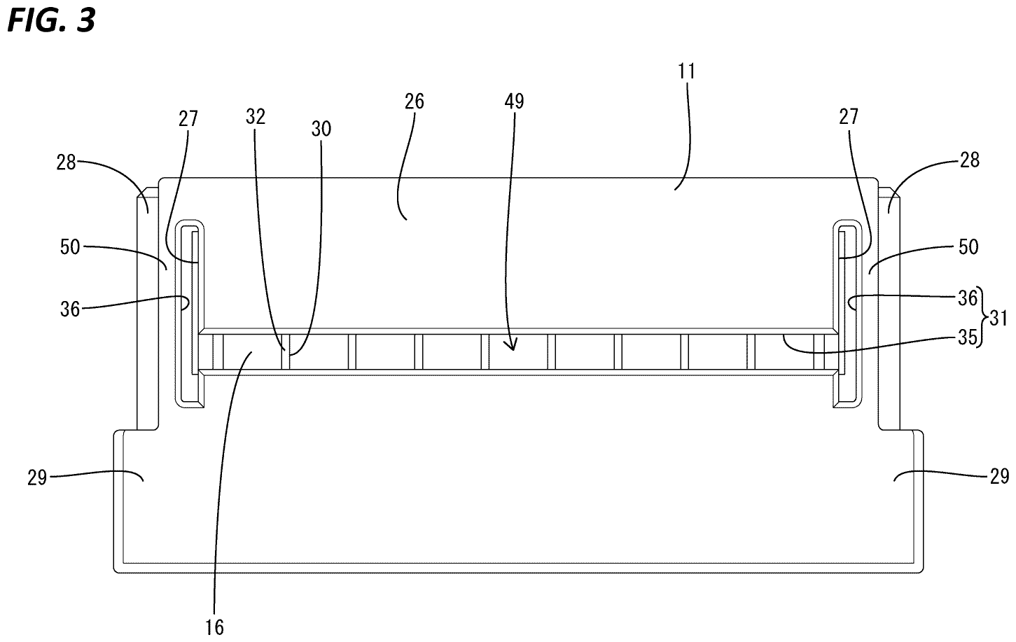

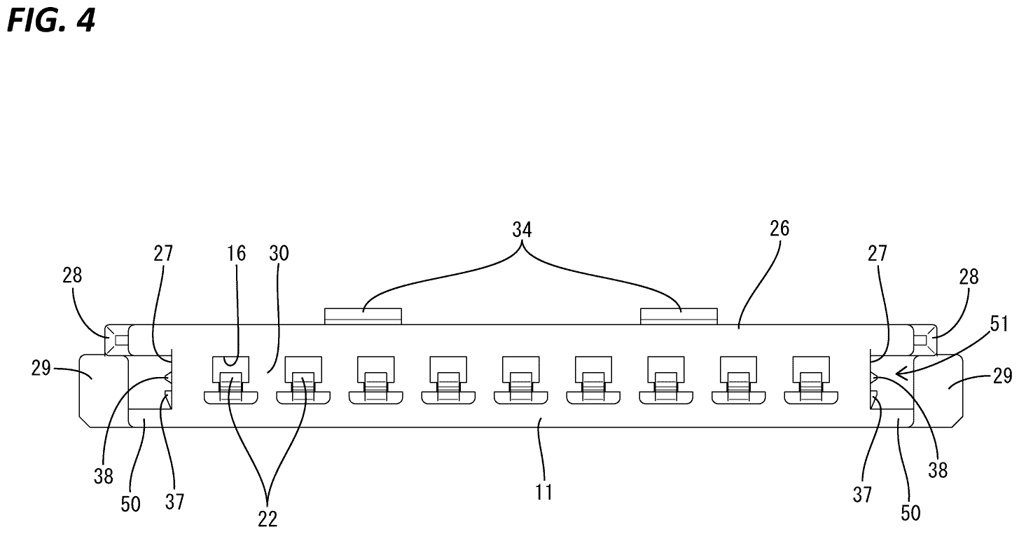

The first housing 11 is made of synthetic resin and, as shown in FIG. 3, includes a housing body portion 26 having a flat rectangular shape. As shown in FIG. 4, the housing body portion 26 is longer in the left-right direction than in the top-bottom direction. The housing body portion 26 of the first housing 11 has a plurality of first cavities 16. The first cavities 16 are lined up in the left-right direction in the housing body portion 26. Each first cavity 16 extends in the front-rear direction and opens at both front and rear end surfaces of the first housing 11. Each first cavity 16 accommodates a respective first terminal fitting 13. As shown in FIG. 3, the first cavities 16 are partitioned by partition portions 30. Each partition portion 30 has a protruding wall portion 32 at a position corresponding to an attaching opening 31, which will be described later. Each protruding wall portion 32 extends downward from the upper wall inside the corresponding cavity 16. Each protruding wall portion 32, along with middle portions of the first cavities 16 that are adjacent to the protruding wall portion 32 in the left-right direction, forms a retainer attaching hole 49 that receives an upper portion of a retainer body portion 39, which will be described later, of the retainer 15. In addition, a lance 22 is formed on an inner wall of each first cavity 16 so as to protrude therefrom. Each lance 22 formed in the corresponding first cavity 16 is elastically deformable and can lock the lance receiving portion 20 of the first terminal fitting 13, properly inserted into the first cavity 16.

A pair of locking protrusions 34 are formed on the upper surface of the housing body portion 26. The locking protrusions 34 are spaced apart from each other on the upper surface of the housing body portion 26. When the stacked connector 10 is accommodated in the connector housing portion 110 of the outer housing 100, each locking protrusion 34 is locked to a locking portion (not shown) inside the connector housing portion 110. This configuration prevents the stacked connector 10 from becoming detached rearward from the outer housing 100.

The attaching opening 31 is open on the bottom surface of the housing body portion 26 (the surface facing the second housing 12). As shown in FIG. 3, in a bottom view of the first housing 11, the attaching opening 31 includes a body attaching opening 35 that is elongated in the left-right direction and a pair of lock attaching openings 36 that are elongated in the front-rear direction respectively from the two ends of the body attaching opening 35.

An upper portion of the retainer body portion 39 of the retainer 15 is fitted into and attached to the retainer attaching holes 49 of the first housing 11 through the body attaching opening 35. When the retainer 15 is attached to the retainer attaching holes 49 of the first housing 11, the first locking portions 23 of the retainer 15, which will be described later, enter the retainer attaching holes 49 through the body attaching opening 35. Similarly, the second locking portions 24, which will be described later, enter the retainer attaching holes 49 of the second housing 12 through the body attaching opening 35 opened on the bottom surface of the second housing 12.

As shown in FIGS. 1 and 4, the first housing 11 has a pair of left and right bulging portions 28 formed at upper end portions of the left and right side surfaces of the housing body portion 26, and a pair of left and right retainer holding walls 50 formed at lower end portions of the left and right side surfaces of the housing body portion 26. The bulging portions 28 protrude from the housing body portion 26 toward the left and right sides. Each bulging portion 28 extends rearward in a rib-like shape from the vicinity of the front end of the housing body portion 26. In the process of accommodating the stacked connector 10 in the connector housing portion 110 of the outer housing 100, a leading end portion of each bulging portion 28 is inserted into a groove (not shown) of the connector housing portion 110. Thus, the operation of attaching the stacked connector 10 to the outer housing 100 is guided.

The retainer holding walls 50 bulge outward to the left and right from the housing body portion 26 with a smaller bulging amount than the bulging portions 28. The retainer holding walls 50 of the first housing 11 and the retainer holding walls 50 of the second housing 12 face and contact each other when stacked. The lock attaching openings 36 extend in the top-bottom direction (thickness direction) through the retainer holding walls 50 and open at the upper and lower surfaces of the retainer holding walls 50.

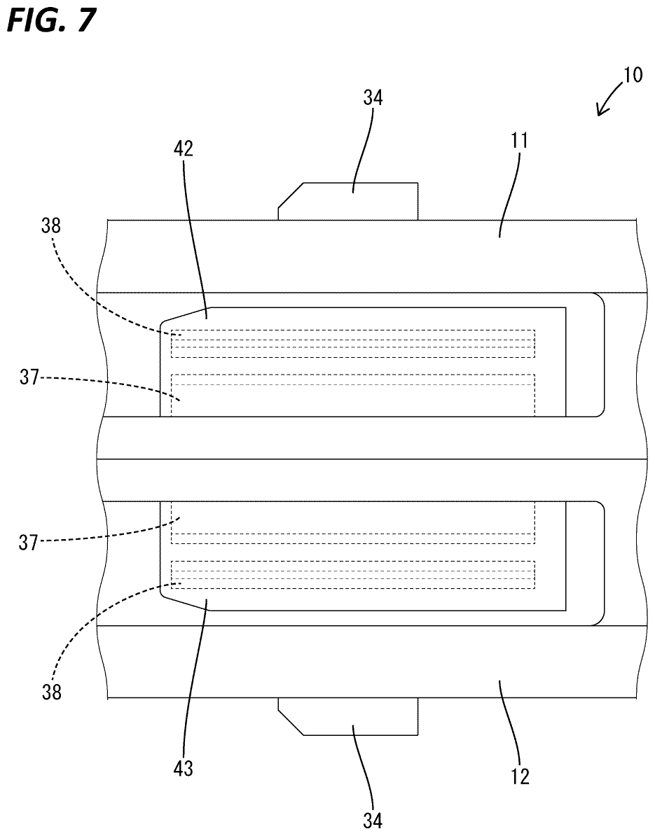

The first housing 11 has a pair of left and right recesses 51 on the left and right side surfaces of the housing body portion 26, each recessed relatively inward in the left-right direction between the retainer holding wall 50 and the bulging portion 28 on the corresponding side, and a pair of left and right lock wall portions 27 respectively formed on the left and right inner rear surfaces of the recesses 51. The lock wall portions 27 constitute the left and right outer side walls of the first cavities 16 located at the left and right ends of the housing body portion 26. On the left and right outer side surfaces of the lock wall portions 27, a temporary locking protrusion 37 and a main locking protrusion 38 are formed so as to be spaced apart from each other in the top-bottom direction. The temporary locking protrusions 37 are disposed below the main locking protrusions 38. As shown in FIG. 7, both the temporary locking protrusions 37 and the main locking protrusions 38 have a rib-like shape that extends in the front-rear direction.

As shown in FIG. 3, the first housing 11 has a pair of left and right stopper portions 29 that protrude outward to the left and the right from a rear end portion of the housing body portion 26. The stopper portions 29 define the rear ends of the recesses 51. When the stacked connector 10 is accommodated in the connector housing portion 110 of the outer housing 100, the stopper portions 29 abut against stopper engagement portions (not shown) of the connector housing portion 110 of the outer housing 100. This configuration prevents the stacked connector 10 from becoming detached forward from the outer housing 100. It should be noted that the second housing 12 has second cavities 16 as portions corresponding to the first cavities 16. Since the first cavities 16 and the second cavities 16 are the same portions in the respective configurations of the first housing 11 and the second housing 12, the same reference numeral is used for both. In addition, the first housing 11 and the second housing 12 do not have locking portions for maintaining their stacked state. As described later, the stacked state of the first housing 11 and the second housing 12 is maintained by the retainer 15. In other words, the retainer 15 includes portions corresponding to the locking portions for maintaining the first housing 11 and the second housing 12 in a stacked state.

### Retainer 15

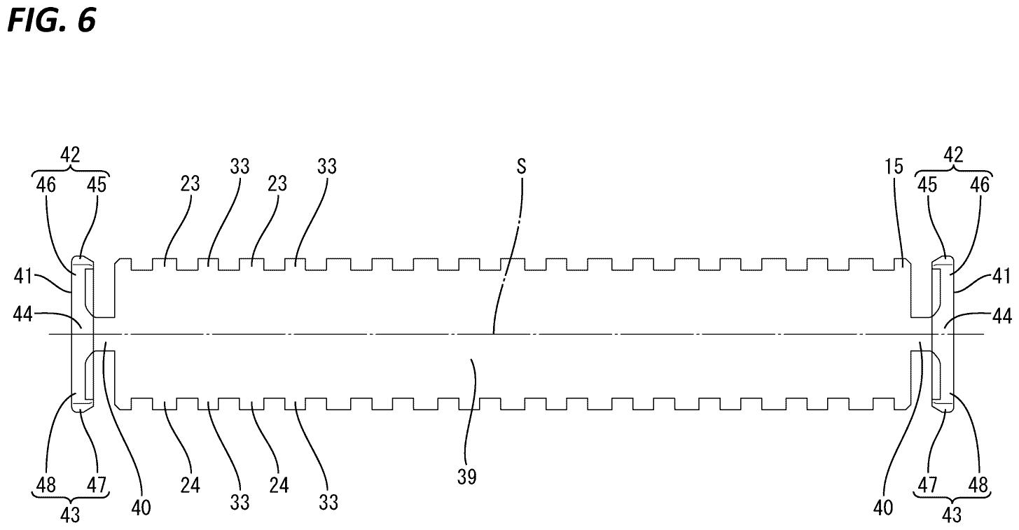

The retainer 15 is made of synthetic resin and includes the retainer body portion 39. As shown in FIG. 6, the retainer body portion 39 has a flat plate shape longer in the left-right direction than in the top-bottom direction and is disposed with its plate surface oriented in the front-rear direction. The upper portion of the retainer body portion 39 is inserted into the retainer attaching holes 49 of the first housing 11, and the lower portion of the retainer body portion 39 is inserted into the retainer attaching holes 49 of the second housing 12.

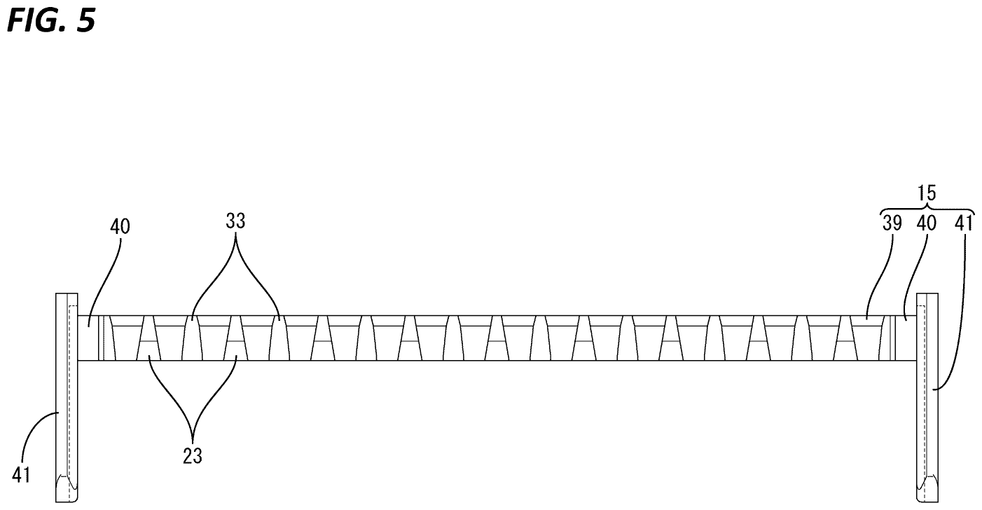

A plurality of first locking portions 23 are formed so as to protrude from the upper end of the retainer body portion 39. The first locking portions 23 are spaced apart from each other in the left-right direction at the upper end of the retainer body portion 39. The front end face of each first locking portion 23 is flush and continuous with the front surface of the retainer body portion 39. As shown in FIG. 5, each first locking portion 23 has a rib shape that extends in the front-rear direction. Specifically, each first locking portion 23 gradually increases the dimension thereof in the left-right direction from the rear end toward the front end. When the first terminal fittings 13 are inserted into the first cavities 16 to the proper positions, the first locking portions 23 face the lock engagement portions 21 from the rear, which is the detachment direction from the first cavities 16.

In addition, as shown in FIG. 6, a plurality of protrusions 33 are formed so as to protrude from the upper end of the retainer body portion 39. The protrusions 33 are spaced apart from each other in the left-right direction. The protrusions 33 and the first locking portions 23 are arranged alternately in the left-right direction at the upper end of the retainer body portion 39. Each protrusion 33 has a rib shape that extends in the front-rear direction. Specifically, each protrusion 33 gradually increases the dimension thereof in the left-right direction from the rear end toward the front end. When the upper portion of the retainer body portion 39 is inserted into the retainer attaching holes 49 of the first housing 11, the protrusions 33 face the protruding wall portions 32 of the first housing 11 in the top-bottom direction. By facing each other, the protrusions 33 and the protruding wall portions 32 function as partitions of the cavities 16, in the same manner as the partition portions 30 other than the protruding wall portions 32.

A plurality of second locking portions 24 are formed so as to protrude from the lower end of the retainer body portion 39. The second locking portions 24 have the same shape as the first locking portions 23. The second locking portions 24 are spaced apart from each other in the left-right direction at the lower end of the retainer body portion 39. When the second terminal fittings 14 are inserted into the second cavities 16 to the proper positions, the second locking portions 24 face the lock engagement portions 21 from the rear, which is the detachment direction from the second cavities 16.

In addition, protrusions 33 are also formed so as to protrude from the lower end of the retainer body portion 39. The protrusions 33 formed at the lower end of the retainer body portion 39 are arranged alternately with the second locking portions 24 in the left-right direction. When the lower portion of the retainer body portion 39 is inserted into the retainer attaching holes 49 of the second housing 12, the protrusions 33 face the protruding wall portions 32 of the second housing 12 in the top-bottom direction.

The retainer 15 has a pair of left and right connecting portions 40 that protrude a short distance outward in the left-right direction from intermediate portions in the top-bottom direction (excluding the end portions in the top-bottom direction) of the left and right side surfaces of the retainer body portion 39. The retainer 15 also has a pair of elastic locking portions 41 extending in both top-bottom directions from intermediate portions 44, which are the outer ends of the connecting portions 40 in the left-right direction. Each elastic locking portion 41 has a flat plate shape longer in the front-rear direction than in the top-bottom direction in a side view and is disposed with its plate surface oriented in the left-right direction.

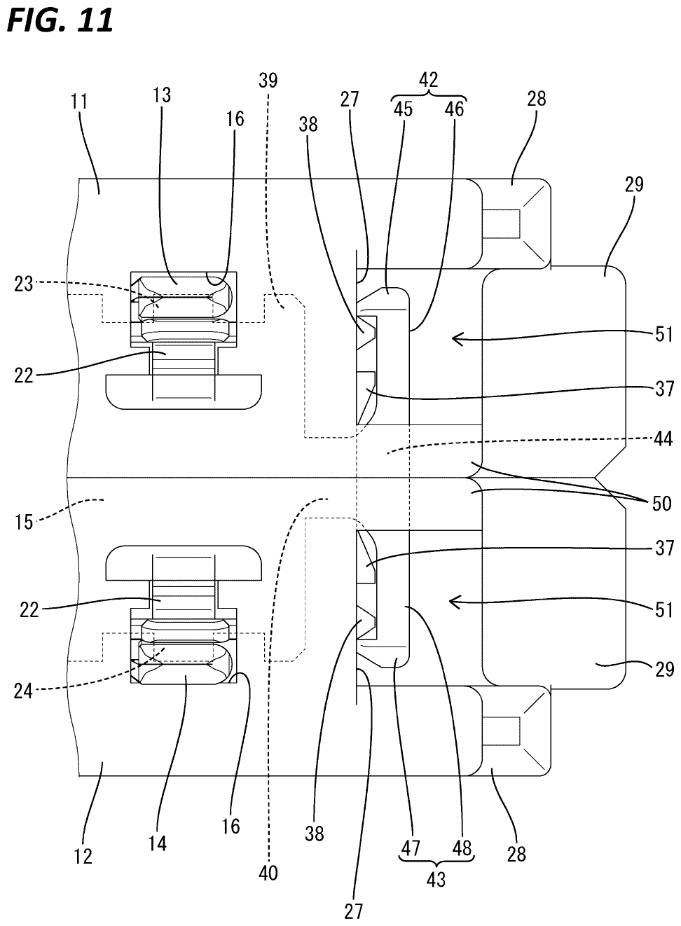

Each elastic locking portion 41 is disposed so as to face a corresponding one of the left and right side surfaces of the retainer body portion 39 with a spacing therebetween in the left-right direction. As shown in FIG. 11, each lock wall portion 27 described above is interposed in the space between the corresponding elastic locking portion 41 and the retainer body portion 39 in the left-right direction. The elastic locking portions 41 include a pair of left and right first elastic locking portions 42 protruding upward from the intermediate portions 44 and a pair of left and right second elastic locking portions 43 protruding upward from the intermediate portions 44. The first elastic locking portions 42 and the second elastic locking portions 43 have the same shape and are arranged symmetrically above and below the intermediate portions 44. The first elastic locking portions 42 and the second elastic locking portions 43 are elastically deformable in the left-right direction about respective base portions connected to the intermediate portions 44. Each first elastic locking portion 42 includes a first locking claw 45 and a first locking body portion 46. The first locking body portion 46 is a plate-shaped portion that protrudes upward from the intermediate portion 44. The plate thickness (left-right dimension) of the first locking body portion 46 is smaller than the thickness of the intermediate portion 44 in the top-bottom direction. The first locking claw 45 constitutes an upper end portion of the first elastic locking portion 42 and protrudes inward in the left-right direction from the first locking body portion 46. The first locking claw 45 is formed so as to extend in the front-rear direction with respect to the first elastic locking portion 42. The first locking claw 45 is engageable with the temporary locking protrusion 37 and the main locking protrusion 38.

The second elastic locking portion 43 has the same shape as the first elastic locking portion 42 and includes a second locking body portion 48 that protrudes downward from the intermediate portion 44 and a second locking claw 47 that protrudes inward in the left-right direction from the second locking body portion 48. Similarly to the first locking claw 45, the second locking claw 47 is engageable with the temporary locking protrusion 37 and the main locking protrusion 38. In the first embodiment, as shown in FIG. 6, the retainer 15 has a symmetric shape with respect to a symmetry line S that passes through the center of the retainer 15 in the top-bottom direction and extends in the left-right direction.

### Assembly Procedure for Stacked Connector 10

Next, an example of an assembly procedure for the stacked connector 10 will be described.

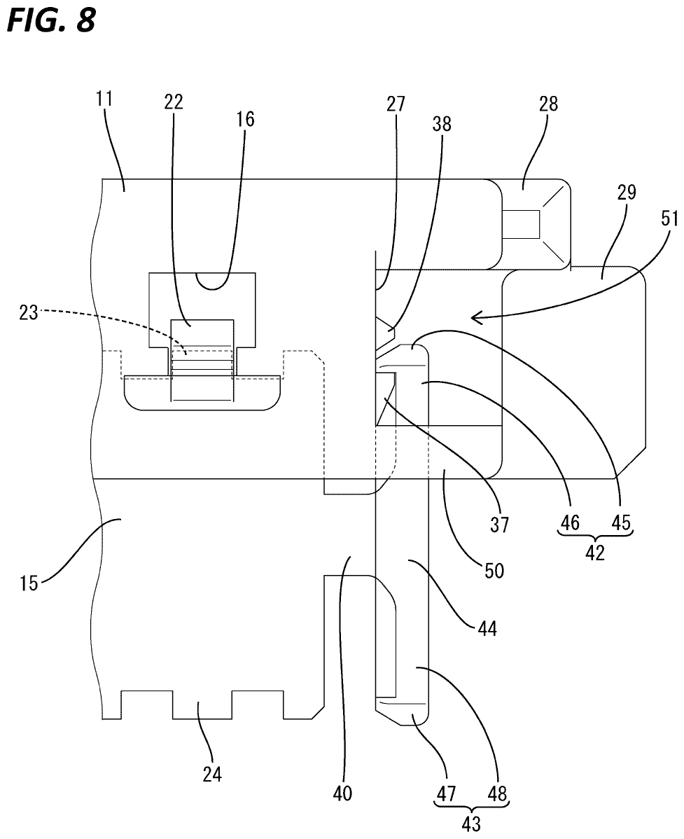

First, the upper portion of the retainer 15 is inserted into the retainer attaching holes 49 from the attaching opening 31 on the bottom surface of the first housing 11. The first elastic locking portions 42 are positioned in the recesses 51 through the lock attaching opening 36 of the first housing 11. The first locking claws 45 come into contact with the temporary locking protrusions 37 and the first elastic locking portions 42 elastically deform outward in the left-right direction. The first locking claws 45 face the upper ends of the temporary locking protrusions 37, and the first elastic locking portions 42 elastically return to their original shape. As shown in FIG. 8, the retainer 15 is held in a temporary locking position with respect to the first housing 11.

While the retainer 15 is in the temporary locking position with respect to the first housing 11, the first terminal fittings 13 are inserted into the first cavities 16 from the rear of the first housing 11. Upon completion of the task of inserting all the first terminal fittings 13 into the first cavities 16, the retainer 15 is pushed upward, thereby releasing the engagement between the first locking claws 45 and the temporary locking protrusions 37. As a result, the retainer 15 becomes movable upward with respect to the first housing 11. During the upward movement of the retainer 15, the first locking claws 45 come into contact with the main locking protrusions 38, and the first elastic locking portions 42 elastically deform outward in the left-right direction.

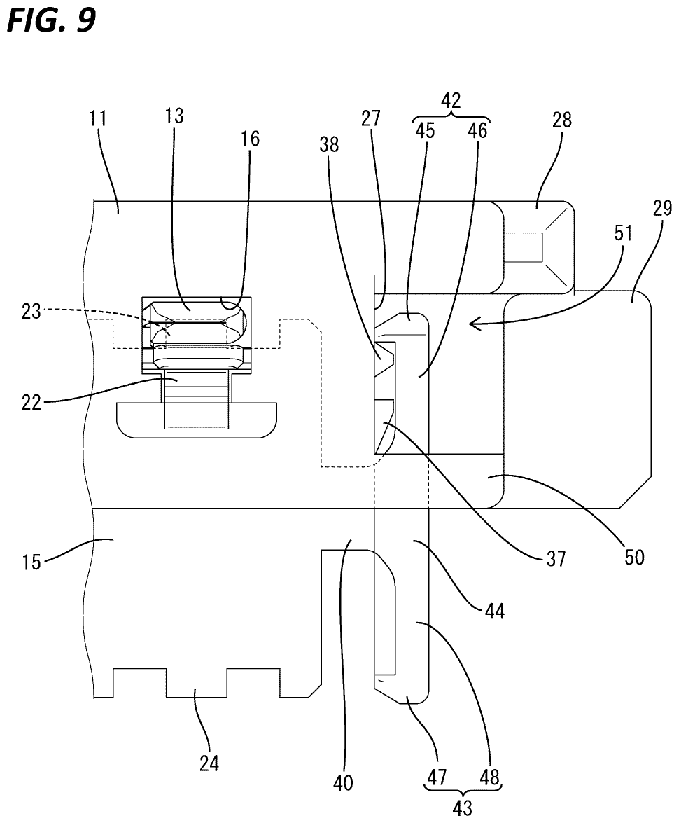

If all the first terminal fittings 13 are inserted into the first cavities 16 at their proper positions, the lance receiving portions 20 of the first terminal fittings 13 are locked by the lances 22 of the first housing 11 (see FIG. 2). Then, the first elastic locking portions 42 elastically return to their original shape, and, as shown in FIG. 9, the first locking claws 45 are positioned so to face the upper ends of the main locking protrusions 38 and to be engageable with them, whereby the retainer 15 is held in the main locking position with respect to the first housing 11. At this time, the first locking portions 23 are positioned so as to face the lock engagement portions 21 of the first terminal fittings 13 from the rear, and to be engageable with them. Therefore, the lances 22 and the first locking portions 23 can prevent the first terminal fittings 13 from becoming detached rearward from the first cavities 16.

In contrast, when at least one of the first terminal fittings 13 is not inserted to the proper position with respect to the corresponding first cavity 16, i.e., is in a half-inserted state, the first locking portion 23 does not become engageable with the half-inserted first terminal fitting 13 in the detachment direction, and instead abuts against the lower surface of the terminal body portion 17, for example. As a result, the first locking claws 45 cannot be positioned so as to be engageable with the upper ends of the main locking protrusions 38. Therefore, the elastically deformed state of the first elastic locking portions 42 is not released, and the retainer 15 cannot reach the main locking position with respect to the first housing 11. Therefore, it can be determined that the first terminal fitting 13 is in a half-inserted state in the first cavity 16 based on the fact that the retainer 15 is prevented from being moved to the main locking position with respect to the first housing 11.

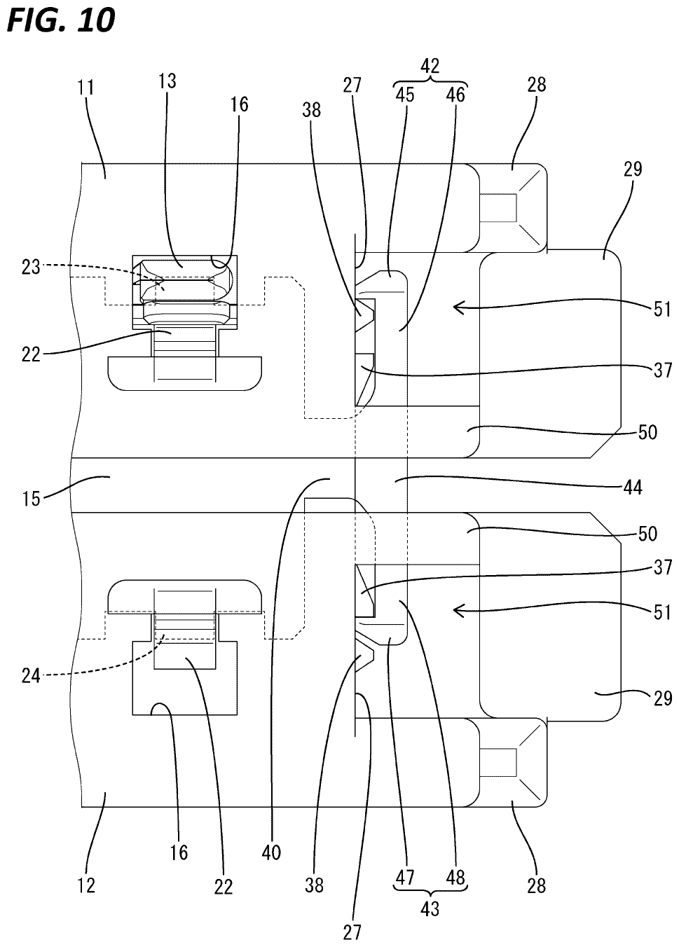

After confirming that all the first terminal fittings 13 are properly inserted into the first cavities 16 through the above-described operation, the lower portion of the retainer 15 is then inserted into the retainer attaching holes 49 through the attaching opening 31 on the upper surface of the second housing 12. As shown in FIG. 10, the retainer 15 is held in a temporary locking position with respect to the second housing 12 by engaging the second locking claws 47 with the temporary locking protrusions 37 of the second housing 12. Upon completion of the task of inserting all the second terminal fittings 14 into the second cavities 16, the retainer 15 is pushed to move to the main locking position. Similarly to the above, if all the second terminal fittings 14 are inserted into the second cavities 16 at their proper positions, the lance receiving portions 20 of the second terminal fittings 14 are locked by the lances 22 of the second housing 12, and the second locking claws 47 are positioned so as to face the lower ends of the main locking protrusions 38, and to be engageable with them. As shown in FIG. 9, the retainer 15 is held in the main locking position with respect to the second housing 12. The second locking portions 24 are positioned so as to be engageable with the lock engagement portions 21 of the second terminal fittings 14 from the rear, thereby secondarily preventing the second terminal fittings 14 from becoming detached rearward from the second cavities 16.

When the retainer 15 reaches the main locking position with respect to the second housing 12, the first housing 11 and the second housing 12 can also reach a proper stacked state (in the first embodiment, a state in which the lower surface of the first housing 11 and the upper surface of the second housing 12 are in contact with each other). Then, the first housing 11 and the second housing 12 can maintain a state in which they are held (connected) to each other by the retainer 15.

In contrast, when at least one of the second terminal fittings 14 is in a half-inserted state with respect to the corresponding second cavity 16, the second locking portions 24 are not positioned so as to be engageable with the half-inserted second terminal fitting 14 in the detachment direction, and instead abuts against the upper surface of the terminal body portion 17, for example. As a result, the second locking claws 47 cannot be positioned so as to be engageable with the lower ends of the main locking protrusions 38, and the retainer 15 cannot reach the main locking position with respect to the second housing 12. Therefore, it can be determined that the second terminal fitting 14 is in a half-inserted state in the second cavity 16 based on the fact that the retainer 15 is prevented from being moved to the main locking position with respect to the second housing 12.

### Function of Stacked Connector 10

According to the first embodiment, the retainer 15 is sequentially engaged with the first housing 11 and the second housing 12, and the half-inserted state of the first terminal fittings 13 with respect to the first cavities 16 and the half-inserted state of the second terminal fittings 14 with respect to the second cavities 16 can be sequentially checked. Therefore, the half-inserted states of the first terminal fitting 13 and the second terminal fitting 14 can be individually detected. In particular, in the case of the first embodiment, since the retainer 15 is shared between both the first housing 11 and the second housing 12, there is an advantage in that the number of parts can be reduced compared to a case where separate retainers are provided for the first housing 11 and the second housing 12.

In addition, the first housing 11 and the second housing 12 are held in a stacked state by the retainer 15. Due to the presence of the elastic locking portions 41 of the retainer 15, housing locks for maintaining the stacked state between the first housing 11 and the second housing 12 can be omitted, and the structures of the first housing 11 and the second housing 12 can be simplified.

The retainer 15 has connecting portions 40 that protrude a short distance in the left-right direction from the intermediate portions of the retainer body portion 39 in the top-bottom direction. The first elastic locking portions 42 and the second elastic locking portions 43 protrude mutually opposite directions in the top-bottom direction from the left and right end portions of the connecting portions 40. Therefore, it is easy to adjust the ranges in which the first elastic locking portions 42 and the second elastic locking portions 43 are connected to the connecting portions 40 and the amount by which they protrude from the connecting portions 40, making it possible to adjust the elastic reaction forces of the first elastic locking portions 42 and the second elastic locking portions 43 to appropriate values.

The retainer 15 has a symmetric shape with respect to the symmetry line S that passes through the center of the retainer 15 in the top-bottom direction and extends in the left-right direction. Therefore, when attaching the retainer 15 to each of the first housing 11 and the second housing 12, the orientation of the retainer 15 in the top-bottom direction need not be distinguished, thereby improving workability during attachment of the retainer 15.

Moreover, since the first housing 11 and the second housing 12 have the same shape, the first housing 11 and the second housing 12 can be assembled in a stacked state without distinguishing them from each other, thereby improving workability during assembly. In addition, the number of types of parts used to form the stacked connector 10 can be reduced.

### Other Embodiments of the Present Disclosure

The embodiments disclosed herein should be regarded as illustrative in all respects and not restrictive.

In the first embodiment described above, the second elastic locking portions of the retainer engage with the main locking protrusions of the second housing, whereby the first housing and the second housing are held in a stacked state with respect to each other by the retainer. In contrast, in another embodiment, the retainer does not necessarily have to have the second elastic locking portions that engage with the second housing. For example, the first housing and the second housing may each have lock portions that are engageable with each other, and the first housing and the second housing may be held in a stacked state by the engagement of the lock portions.

In the first embodiment described above, the first housing and the second housing have the same shape. In contrast, in another embodiment, the first housing and the second housing may have different shapes.

In the first embodiment described above, the first terminal fittings and the second terminal fittings have the same shape. In contrast, in another embodiment, the first terminal fittings and the second terminal fittings may have different shapes.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A stacked connector comprising:
a first housing having a first cavity;
a first terminal fitting configured to be accommodated in the first cavity;
a second housing having a second cavity;
a second terminal fitting configured to be accommodated in the second cavity; and
a retainer configured to be shared between both the first housing and the second housing,
wherein the first housing and the second housing are stacked on each other, and
the retainer includes:
a first locking portion disposed so as to be engageable with the first terminal fitting accommodated in the first cavity, in a detachment direction from the first cavity;
a second locking portion disposed so as to be engageable with the second terminal fitting accommodated in the second cavity, in a detachment direction from the second cavity; and
an elastic locking portion configured to lock the first housing in a state in which the first locking portion is disposed so as to be engageable with the first terminal fitting.

2. The stacked connector according to claim 1,
wherein the elastic locking portion includes a first elastic locking portion configured to lock the first housing, and a second elastic locking portion configured to lock the second housing in a state in which the second locking portion is disposed so as to be engageable with the second terminal fitting, and the first housing and the second housing are held in a stacked state by the retainer.

3. The stacked connector according to claim 2,
wherein, when a direction in which the first housing and the second housing are stacked is defined as a height direction and a direction intersecting the height direction is defined as a width direction,
the retainer includes a retainer body portion having the first locking portion and the second locking portion protruding respectively from two sides in the height direction, and a connecting portion protruding in the width direction from an intermediate portion in the height direction of the retainer body portion,
the first elastic locking portion protrudes from a leading end portion of the connecting portion in a protruding direction toward one side in the height direction, and
the second elastic locking portion protrudes from the leading end portion of the connecting portion in the protruding direction toward the other side in the height direction.

4. The stacked connector according to claim 3,
wherein the retainer has a symmetric shape with respect to a symmetry line passing through the center of the retainer in the height direction and extending in the width direction.

5. The stacked connector according to claim 1,
wherein the first housing and the second housing have the same shape.
